(19) United States
(12) Patent Application Publication
(10) Pub. No.: US 2025/0318004 A1
(43) Pub. Date: Oct. 9, 2025

(54) METHOD AND APPARATUS FOR ESTABLISHING SESSION BASED ON USER DATA IN WIRELESS COMMUNICATION SYSTEM

(71) Applicant: Samsung Electronics Co., Ltd., Gyeonggi-do (KR)

(72) Inventors: Kisuk KWEON, Gyeonggi-do (KR); Naman GUPTA, Gyeonggi-do (KR); Hoyeon LEE, Gyeonggi-do (KR)

(21) Appl. No.: 19/169,395

(22) Filed: Apr. 3, 2025

(30) Foreign Application Priority Data
Apr. 4, 2024 (KR) 10-2024-0046006

(51) Int. Cl. H04W 76/15

(52) U.S. Cl. CPC H04W 76/15

(57) ABSTRACT

The disclosure relates to a 5G or 6G communication system for supporting a higher data transmission rate. According to an embodiment, a method performed by an AMF entity in a mobile communication system includes receiving, from a UE, a PDU session establishment request message including a user identifier and a request type of a PDU session establishment request; identifying that the request type indicates that the PDU session establishment request is for the user identifier; and selecting an SMF entity associated with a PDU session establishment based on the user identifier.

### CROSS-REFERENCE TO RELATED APPLICATION(S)

This application is based on and claims priority under 35 U.S.C. § 119 to Korean Patent Application No. 10-2024-0046006, which was filed in the Korean Intellectual Property Office on Apr. 4, 2024, the entire disclosure of which is herein incorporated by reference.

### BACKGROUND

### 1. Field

The disclosure relates generally to terminal and base station (BS) operations in a wireless communication system, and more particularly, to a method and an apparatus for establishing a data session for a user data transmission of an enhanced network service in a wireless communication system, based on information of a terminal user and subscriber-based data.

### 2. Description of Related Art

5th generation (5G) mobile communication technologies define broad frequency bands such that high transmission rates and new services are possible, and can be implemented in “sub 6 gigahertz (GHz)” bands such as 3.5 GHz, and in “above 6 GHz” bands, which may be referred to as mm Wave, including 28 GHz and 39 GHz.

In addition, it has been considered to implement 6th generation (6G) mobile communication technologies (also referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIOT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expect to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum), and reconfigurable intelligent surface), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a method and an apparatus for storing, in a network, data of a user of a terminal in a wireless communication system and accordingly, providing a network service based on the user data.

In accordance with an aspect of the disclosure, a method is provided for an access and mobility management function (AMF) entity in a mobile communication system. The method includes receiving, from a UE, a protocol data unit (PDU) session establishment request message including a user identifier and a request type of a PDU session establishment request; identifying that the request type indicates that the PDU session establishment request is for the user identifier; and selecting a session management function (SMF) entity associated with a PDU session establishment based on the user identifier.

In accordance with another aspect of the disclosure, a method performed by an SMF entity in a mobile communication system may include receiving, from an AMF entity, a PDU session establishment request message including a user identifier and a request type of a PDU session establishment request; identifying that the request type indicates that the PDU session establishment request is for the user identifier; and receiving, from a unified data management (UDM) entity, user profile information corresponding to the user identifier.

In accordance with another aspect of the disclosure an apparatus and a method are provided for effective provisioning of a service in a wireless communication system.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment;

FIG. 2 illustrates an example of a user identifier (ID) and a user profile according to an embodiment;

FIG. 3 is a signal flow diagram illustrating a method for generating a PDU session based on user profile information according to an embodiment;

FIG. 4 illustrates a UE according to an embodiment; and

FIG. 5 illustrates a BS or a network entity (NE) according to an embodiment.

### DETAILED DESCRIPTION

Hereinafter, various embodiments of the disclosure will be described in detail with reference to the accompanying drawings.

In addition, a detailed description of known functions or configurations that may make the subject matter of the disclosure unclear will be omitted.

In the accompanying drawings, the same or like elements may be designated by the same or like reference signs as much as possible.

Additionally, in the accompanying drawings, some elements may be exaggerated, omitted, or schematically illustrated. Furthermore, the size of each element does not completely reflect the actual size.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure.

The terms which will be described below are terms defined in consideration of the functions in the disclosure, and may be different according to users, intentions of the users, or customs. Therefore, the definitions of the terms should be made based on the contents throughout the specification.

Herein, a BS is an entity that allocates resources to terminals, and may be at least one of a gNode B (gNB), an eNode B (eNB), a Node B, a wireless access unit, a BS controller, and a node on a network. A terminal may include a UE, a mobile station (MS), a cellular phone, a smartphone, a computer, or a multimedia system capable of performing a communication function.

Herein, a “downlink (DL)” refers to a radio link via which a BS transmits a signal to a terminal, and an “uplink (UL)” refers to a radio link via which a terminal transmits a signal to a BS.

In the following description, long-term evolution (LTE), LTE-advanced (LTE-A), or 5G systems may be described by way of example, but the embodiments of the disclosure may also be applied to other communication systems having similar technical backgrounds or channel types. Examples of such communication systems may include 5G mobile communication technologies (e.g., NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of the 3rd generation partnership project (3GPP), LTE (or evolved universal terrestrial radio access (E-UTRA)), LTE-Advanced (LTE-A), LTE-Pro, high-rate packet data (HRPD) of 3GPP2, ultra-mobile broadband (UMB), IEEE 11 02.16e, etc., as well as typical voice-based services.

As an example of a broadband wireless communication system, an LTE system employs an orthogonal frequency division multiplexing (OFDM) scheme in a DL and employs a single carrier frequency division multiple access (SC-FDMA) scheme in a UL. The UL refers to a radio link via which a UE or an MS transmits data or control signals to a BS, eNode B, or gNode B, and the DL refers to a radio link via which the BS transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, should freely reflect various requirements of users, service providers, etc., services satisfying various requirements should be supported. The services considered in the 5G communication system include eMBB communication, mMTC, URLLC, etc.

eMBB aims at providing a data rate higher than that supported by existing LTE, LTE-A, or LTE-Pro. For example, in the 5G communication system, eMBB should provide a peak data rate of 20 Gbps in the DL and a peak data rate of 10 Gbps in the UL for a single BS. Furthermore, the 5G communication system must provide an increased user-perceived data rate to the UE, as well as the maximum data rate. In order to satisfy such requirements, transmission/reception technologies including a further enhanced MIMO transmission technique are required to be improved. Also, the data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC has requirements, such as support of connection of a large number of UEs in a cell, enhancement coverage of UEs, improved battery time, a reduction in the cost of a UE, etc., in order to effectively provide IoT. Since the IoT provides communication functions while being provided to various sensors and various devices, it should support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC should be configured to be inexpensive, and may require a very long battery life-time such as 10 to 15 years because it is difficult to frequently replace the battery of the UE.

URLLC is a cellular-based mission-critical wireless communication service. Thus, URLLC should provide communication with ultra-low latency and ultra-high reliability. For example, a service supporting URLLC should satisfy an air interface latency of less than 0.5 ms, and also have a packet error rate of 10-5 or less. Therefore, for the services supporting URLLC, a 5G system should provide a transmit time interval (TTI) shorter than those of other services, and also may require a design for assigning a large number of resources in a frequency band in order to secure reliability of a communication link.

The three services in 5G, i.e., eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the disclosure, a network technology may refer to a standard specification (e.g., TS 23.501, TS 23.502, TS 23.503, etc.) defined by the international telecommunication union (ITU) or 3GPP, and each element included in a network structure may indicate a physical entity, or software performing an individual function or hardware combined with the software.

In the following description, terms for identifying access nodes, terms referring to NEs or network functions (NFs), terms referring to messages, terms referring to interfaces between NE, terms referring to various identification information, etc., are illustratively used for the sake of descriptive convenience. Therefore, the disclosure is not limited by the terms as described below, and other terms referring to subjects having equivalent technical meanings may also be used.

In the following description, some of terms and names defined in the 3GPP standards may be used for the sake of descriptive convenience. However, the disclosure is not limited by these terms and names, and may be applied in the same way to systems that conform other standards.

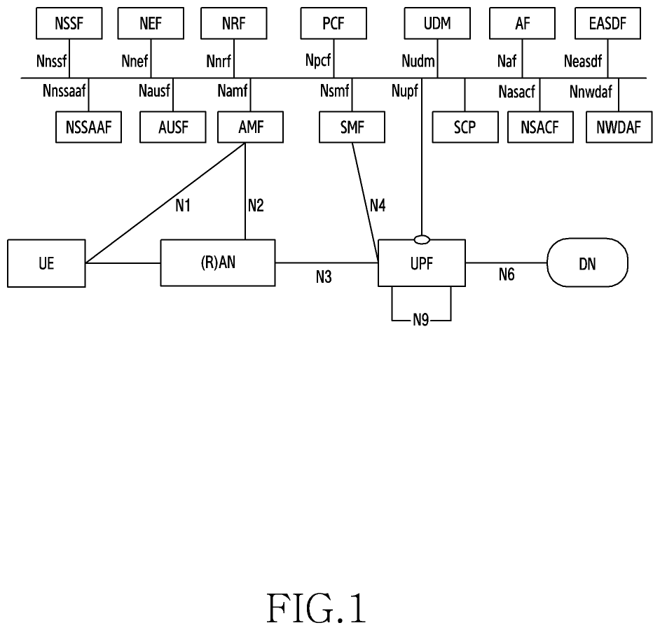

FIG. 1 illustrates a wireless communication system according to an embodiment. More specifically, FIG. 1 illustrates an example of a configuration of a 5G system.

Referring to FIG. 1, a 5G network includes at least one of NEs or NFs described as follows.

A (radio) access network ((R) AN) is a subject that performs wireless resource allocation for a UE, and may include at least one of an eNode B, a node B, a BS, a next generation radio access network (NG-RAN), a 5G access network (5G-AN), a 5G NR, a wireless access unit, a BS controller, or a node on the network.

A UE may include a next generation (NG) UE, an MS, a cellular phone, a smartphone, a computer, an IoT device, or a multimedia system capable of a communication function.

In addition, in the following description, an embodiment of the disclosure is described by using a 5G system as an example, but the embodiment of the disclosure may be also applied to other communication systems having similar technical backgrounds. In addition, an embodiment of the disclosure may be also applied to other communication systems through partial modification without departing too far from the scope of the disclosure according to the determination of a person skilled in the art.

As wireless communication systems evolve from 4th generation (4G) systems to 5G systems, a new core network (CN), referred to as an NG core or a 5G CN (5GC), is defined. The new CN may fully virtualize existing NEs to transform same into NFs. An NF may refer to an NE, a network component, and a network resource.

A 5GC may include one or more NFs. However, the disclosure is not limited to the example of FIG. 1 and a 5GC may include more or fewer NFs than illustrated in FIG. 1.

An AMF may be an NF that manages access and mobility of a UE. For example, the AMF may perform NFs such as registration, connection, reachability, mobility management, access verification, authentication, and mobility event generation for a UE.

An SMF may be an NF that manages packet data network (PDN) connection provided to a UE. PDN connection may be called a PDU session. For example, the SMF may perform NFs, such as an SMF including session establishment, modification, release, and tunnel maintenance between a user plane function (UPF) and the RAN required for same, user plane (UP) selection and control, traffic processing control at the UPF, and charging data collection control.

A policy control function (PCF) may be an NF that applies a service policy, a charging policy, and a PDU session policy of a mobile communication service provider to a UE.

A UDM may be an NF that stores information about a subscriber. For example, the UDM may perform functions such as generating authentication information for 3GPP security, processing a user ID, managing a list of NFs supporting a UE, and managing subscription information.

A network exposure function (NEF) may be a function that provides information about a UE to a server located outside the 5G network. Additionally, the NEF may provide a function that provides information required for a service to the 5G network and stores same in a unified data repository (UDR).

A UPF may function as a gateway that transfers user data (e.g., a PDU) to a data network (DN). More specifically, the UPF may process data to transfer data transmitted by a UE to an external network or transfer incoming data from an external network to a UE. For example, the UPF may perform NFs such as acting as an anchor between radio access technologies (RAT), packet routing and forwarding, packet inspection, UP policy application, creating a traffic usage report, and buffering.

A network repository function (NRF) may perform a function that stores the profiles of NFs and performs NF discovery.

An authentication server function (AUSF) may perform UE authentication in a 3GPP access network and a non-3GPP access network.

A network slice selection function (NSSF) may perform a function that selects a network slice instance provided to a UE.

A network data analytics function (NWDAF) may collect pieces of data from various NFs for the efficient operation of the 5GC network. The collected data may be analyzed using an ML model, and a result of the analysis may be provided back to the NFs to help each NF to provide an efficient network service.

An application function (AF) may communicate with a service provider network to allow an external server (application server) to use a network service provided by the service provider network. The AF may be classified into an internal AF and an external AF according to a deployment entity. An internal AF deployed by a network service provider may directly communicate with NFs within the service provider's network. An AF deployed by a service provider (a 3rd party service provider) may need to pass through the NEF to communicate with NFs within the service provider's network.

ADN may be a network through which a UE transmits and receives data to use a service of a network service provider or a 3rd party service.

A network slice admission control function (NSACF) may limit the number of PDU sessions for a registered UE in each slice and perform a function of managing resources through the limitation.

A network slice-specific authentication and authorization function (NSSAAF) may create a slice authentication context for a UE and perform an authentication and authorization procedure for each slice.

An edge application server discovery function (EASDF) may perform a function that generates a domain name system (DNS) context for a PDU session and stores, in the context, a UE Internet protocol (IP) address and a DNS message processing rule.

A service communication proxy (SCP) may perform an indirect communication function that proxies service discovery and request and response.

A UE may include an IoT device. The IoT device may include a device that does not use battery power or operates with extremely low power, and such the IoT device may be referred to as an ambient IoT device.

In a 3GPP system, a conceptual link connecting NFs in a 5G system is defined as a reference point. The following example shows reference points included in a 5G system architecture expressed in FIG. 1.
N1: A reference point between the UE and the AMF
N2: A reference point between the (R) AN and the AMF
N3: A reference point between the (R) AN and the UPF
N4: A reference point between the SMF and the UPF
N6: A reference point between the UPF and the DN
N9: A reference point between two core UPFs

Additionally, in a 3GPP system, a 5G system architecture may include service-based interfaces as shown in the following example.
Nnssf: An interface based on a service by the NSSF
Nnssaaf: An interface based on a service by the NSSAAF
Nnef: An interface based on a service by the NEF
Nausf: An interface based on a service by the AUSF
Nnrf: An interface based on a service by the NRF
Namf: An interface based on a service by the AMF
Npcf: An interface based on a service by the PCF
Nsmf: An interface based on a service by the SMF
Nupf: An interface based on a service by the UPF
Nudm: An interface based on a service by the UDM
Naf: An interface based on a service by the AF
Nasacf: An interface based on a service by the NSACF
Neasdf: An interface based on a service by the EASDF
Nnwdaf: An interface based on a service by the NWDAF

Mobile communication service providers may use a user ID for identifying a user that uses a UE in order to provide an actual UE user-customized network service to users using the UE. For example, a user ID may be used because a UE subscriber and a user who actually uses a UE may be different, if a user-customized service is provided based on only UE subscriber information, a service different from a service desired by a user actually using a UE may be provided. Therefore, in accordance with an embodiment of the disclosure, a user profile including information on a user actually using a UE is additionally stored in a network, and a user ID of the user currently using the UE is provided to the network, and therefore, a user-customized network service may be provided to the actual UE user, based on user profile information identified by the user ID.

In order to provide a service customized for an actual UE user to the user described above, a method by which a PDU session is generated based on UE user information in addition to existing subscriber information so as to provide a user-customized network service is provided.

### User Identities and Authentication Architecture (UIA_ARC)

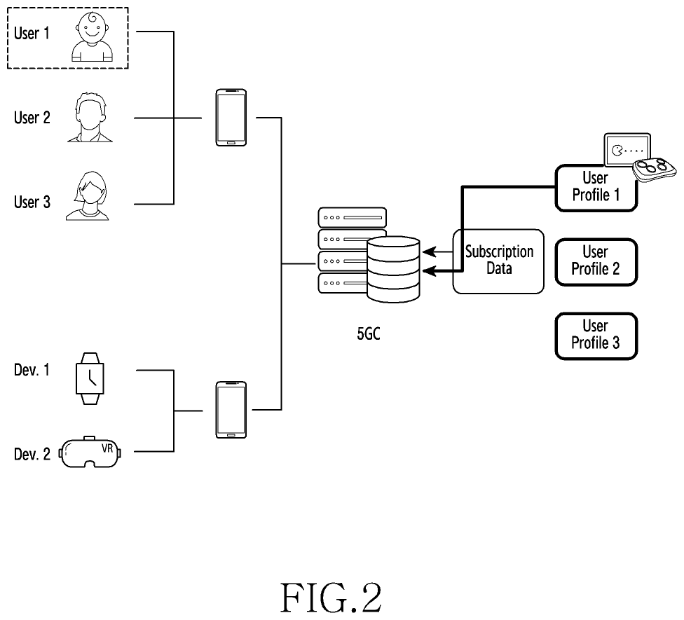

FIG. 2 illustrates an example of a user ID and a user profile according to an embodiment. For example, there may be two scenarios in which a user ID is used. The first scenario include a case where multiple human users uses a UE, and the second scenario may include a scenario where multiple devices are connected to a single UE. In the first scenario, the UE may include various devices, such as a car, a TV, a public computing, etc., as well as a mobile phone. Referring to FIG. 2, when user 1 is using a UE, a registered owner who has subscribed to the UE may not be user 1. For example, the registered subscriber of the UE may be the father or mother of user 1. Subscriber information (e.g., subscription data) based on the name of the subscriber may be different from the preference of user 1 currently using the UE. When a user-customized network service is provided based on existing subscriber information, the network service may be different from that desired by user 1 who is a current UE user, and thus a significant discrepancy may arise. For example, a service mainly used by the subscriber of the UE may be Internet browsing and office-related applications, whereas a service mainly used by user 1 may be games.

In order to overcome the limitations of a network customized service based on subscriber information described above, an actual UE user-customized network service based on a user ID and a user profile is provided. To this end, a network may store subscriber information as well as user profile information that is information of users using a UE. In addition, a user ID for distinguishing a user currently using the UE may be provided to the network in addition to a subscriber ID, and the network may be configured to be optimized to a service preferred by the current UE user, based on subscriber information and a user profile.

For example, referring to FIG. 2, a network configuration value may be set to be optimized to a game service preferred by user 1, who is a child, by referring to subscriber information and a user profile including information of user 1 when user 1 uses the UE.

### User Profile

Table 1 shows content related to access and mobility management (AM) user profile information among user profile information for providing a UE user-customized service.

TABLE 1

| User Profile | | |
|---|---|---|
| data type | Field | Description |
| User | User ID | Identify the User and the |
| Profile_AM | | associated User Profile. |
| | Security | Used for authentication/ |
| | Credential | authorization of the User. |
| | UI-AMBR | The maximum aggregated |
| | | UL and DL maximum |
| | | bit rates (MBRs) to be |
| | | shared across all Non- |
| | | guaranteed bit rate |
| | | (GBR) quality of service |
| | | (QoS) Flows according |
| | | to the User. |
| | UI-Slice-MBR(s) | List of maximum aggregated |
| | | UL and DL MBRs |
| | | to be shared across all |
| | | GBR and Non-GBR QoS |
| | | Flows related to the same |
| | | single (S)-network slice |
| | | selection assistance |
| | | information (NSSAI) |
| | | according to the User. |
| | | There is a single UL and a |
| | | single DL value per S-NSSAI. |
| | UI-Subscribed S- | The Network Slices that |
| | NSSAIs | the UE subscribes to. In |
| | | the roaming case, it |
| | | indicates the subscribed |
| | | Network Slices applicable |
| | | to the Serving public |
| | | land mobile network (PLMN). |
| | | For a subscribed S-NSSAI |
| | | subject to network |
| | | slice admission control |
| | | (NSAC) for the registered |
| | | number of UE, the applicable |
| | | NSAC admission |
| | | mode is included. |
| | Slice Usage Policy | Includes: |
| | information | indication the S-NSSAI |
| | | is on demand; and |
| | | slice deregistration |
| | | inactivity timer value. |
| | | The AMF uses this information. |
| | S-NSSAIs | The Subscribed S-NSSAIs |
| | subject to | marked as subject to |
| | Network Slice- | NSSAA when the User |
| | Specific | is registered. When |
| | Authentication and | present, the GPSI list shall |
| | Authorization | include at least one GPSI. |
| | Network Slice | Optionally, if the |
| | validity time | Subscribed S-NSSAI is |
| | information | temporarily available |
| | | network slice, one validity |
| | | time is associated with this |
| | | S-NSSAI. |
| | UI-Charging | It contains the |
| | Characteristics | Charging Characteristics. |
| | | This information, when |
| | | provided, shall override |
| | | any corresponding |
| | | predefined information at the |
| | | AMF. |
| | UI-PCF Selection | List of combination of data |
| | Assistance info | network name (DNN) |
| | | and S-NSSAI that indicates |
| | | that the same PCF for |
| | | the User needs to be |
| | | selected for AM Policy |
| | | Control and SM Policy Control |
| | List of associated | List of SUPI(s) in a |
| | SUPI(s) | home PLMN (HPLMN) |
| | | which is associated the User. |
| | List of associated | Optionally, List of |
| | PEI(s) | permanent equipment |
| | | identifiers (PEI(s)) in |
| | | HPLMN which is |
| | | associated the User. |

Table 1 described above may include profile information including information related to AM of a user in a user profile.

A user ID may indicate an ID for identifying which user is related to a corresponding user profile.

Security credential may indicate a value used for authentication/authorization of a user when the user registers on a network.

UI-AMBR may indicate a aggregated MBR (AMBR) for each user.

UI-slice-MBR(s) may indicate a slice-MBR(s) for each user.

UI-Subscribed S-NSSAIs may indicate S-NSSAIs to which each user has subscribed.

Slice usage policy information may indicate policy information relating to a subscribed slice of each user.

S-NSSAIs subject to network slice-specific authentication and authorization may include information for authentication/authorization if authentication/authorization is required when a subscribed slice of each user is used.

Network slice validity time information may include validity time information relating to a subscribed slice of each user.

UI-charging characteristics may include information relating to charging when a specific user uses a network service, due to a different network service provided to each user.

UI-PCF selection assistance info may include information relating to user-specific PCF selection based on the fact that PCF selection may be different according to users, due to a different user-specific QoS in order to provide a user-customized service.

List of associated subscription permanent identifier(s) (SUPI(s)) may include a list of subscriber IDs (e.g., SUPIs) of UEs subscribed as users, when a user is a user of multiple UEs subscribed to the same network service provider.

List of associated PEI(s) may include a list of UE IDs PEIs) of UEs subscribed as users, when a user is a user of multiple UEs subscribed to the same network service provider.

Table 2 shows the content related to session management (SM) user profile information among user profile information for providing a UE user-customized service.

TABLE 2

| User Profile | | |
|---|---|---|
| data type | Field | Description |
| User | User Identifier | Identify the User and the |
| Profile_SM | | associated User Profile. |
| | Subscribed DNN list | List of the subscribed DNNs |
| | | for the S-NSSAI. |
| | UI-Slice Usage Policy | Includes: |
| | information | indication the S-NSSAI |
| | | is on demand; and |
| | | PDU Session inactivity |
| | | timer value. |
| | | The SMF uses this information. |
| | UI-Subscribed Qos | The QoS Flow level |
| | profile | QoS parameter values |
| | | (5QI and ARP) for the |
| | | DNN, S-NSSAI. |
| | UI-Charging | It contains Charging |
| | Characteristics | Characteristics. |
| | | This information, |
| | | when provided, shall |
| | | override any |
| | | corresponding predefined |
| | | information at the SMF. |
| | UI-Session-AMBR | The maximum aggregated |
| | | UL and DL MBRs |
| | | to be shared across all |
| | | Non-GBR QoS Flows |
| | | in each PDU Session, |
| | | which are established |
| | | for the DNN, S-NSSAI. |
| | UI-Secondary | Indicates that whether |
| | authentication | the Secondary |
| | indication | authentication/authorization |
| | | is required for |
| | | PDU Session |
| | | Establishment or PDN |
| | | Connection Establishment. |
| | AF-AAA Server | Indicates that whether |
| | UE IP | the SMF is required to |
| | address allocation | request the UE IP address |
| | indication | from the AF-AAA |
| | | Server for PDU Session |
| | | Establishment or |
| | | PDN Connection Establishment. |
| | AF-AAA Server | If at least one of secondary |
| | addressing/credential | AF-AAA authentication, AF-AAA |
| | information | authorization or AF- |
| | | AAA UE IP address |
| | | allocation is required by |
| | | User Profile data, the |
| | | User Profile data may |
| | | also contain AF-AAA |
| | | Server addressing and |
| | | AF-specific credential information. |

Table 2 described above may include profile information including information related to SM of a user in a user profile.

A user ID may indicate an ID for identifying which user is related to a corresponding user profile.

Subscribed DNN list may indicate a list of DN names (DNNs) of each subscribed S-NSSAI of each user.

UI-slice usage policy information may indicate policy information relating to a subscribed slice of each user.

UI-subscribed QoS profile may include a subscription QoS profile for each user.

UI-charging characteristics may include information relating to charging when a specific user uses a network service, due to a different network service provided to each user.

UI-session-AMBR may indicate a session-AMBR for each user.

UI-secondary authentication indication may indicate whether secondary authentication for accessing a subscribed DNN of each user is performed.

AF-AAA server UE IP address allocation indication may indicate whether an AF used by each user requests a UE IP address.

AF-AAA Server addressing/credential information may include information for an UI-secondary authentication indication when the UI-secondary authentication indication exists in a subscribed DNN of each user.

Various embodiments of the disclosure do not limit user profile information to the user profile information described above. If necessary, some of the above information or more other information may be included in user profile information.

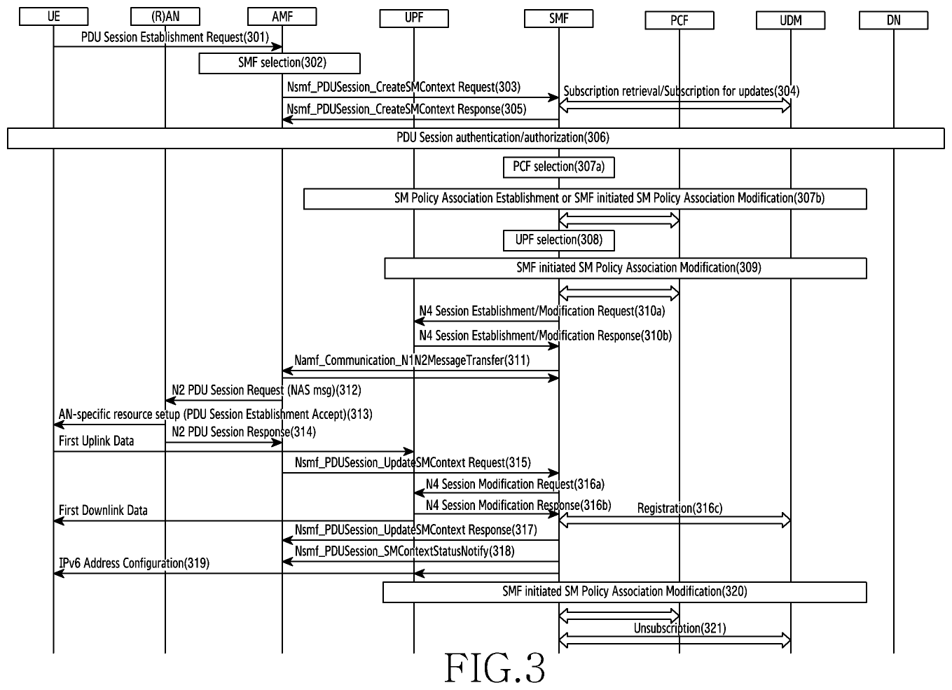

FIG. 3 is a signal flow diagram illustrating a method for generating a PDU session based on user profile information according to an embodiment.

Referring to FIG. 3, a UE may request, through an AMF, an SMF to establish a PDU session. More specifically, when a new service data flow occurs, if there is no proper PDU session for transmitting the flow, the UE may perform a new PDU session generation procedure. To this end, the UE may transmit a PDU session establishment request message to the AMF in step 301. The message transmitted by the UE may be also transmitted to the SMF via the AMF.

A non-access stratum (NAS) message including the PDU session establishment request message may include at least one of the following: S-NSSAI(s), [Alternative S-NSSAI], UE Requested DNN, PDU Session ID, Request type, and Old PDU Session ID.

The PDU session establishment request message transmitted to the SMF may include at least one information of a PDU session ID, a requested PDU session type, a requested session and service continuity (SSC) mode, a 5G session management (5GSM) capability, a protocol configuration option (PCO), an SM PDU DN request container, the number of packet filters, a header compression configuration, a UE integrity protection maximum data rate, an always-on PDU session requested, a redundancy sequence number (RSN), connection capabilities, or a PDU session pair ID.

If a request type is set to be “Initial Request with UI,” this may indicate a request to generate a PDU session by considering even user profile information. Accordingly, at least one of a user ID, a user-specific requested DNN, or S-NSSAI information for identifying a user and corresponding user profile information may be further included.

In step 302, the AMF may select an SMF. More specifically, the AMF may receive a PDU session establishment request message and select a proper SMF.

The AMF may consider at least one of the following information to select an SMF: a DNN, an S-NSSAI, an access technology, support for CP CIOT 5GS optimization, subscription information from a UDM, local service provider (operator) policies, load conditions of SMFs (candidate SMFs), UE location, service area of SMFs, or a target DNAI.

If a message from the UE indicates that a PDU session is to established for user identifier(s) (e.g. a request type is set to be “Initial Request with UI,” or UE transmits an indication informing session is for user identifier(s)), the AMF may select an SMF capable of generating a PDU session which considers user profile information or an SMF that supports user identifier(s). In addition, the AMF may select a different SMF for each user. If an available S-NSSAI and DNN are distinguishable for each user, the AMF may check an authority of the user.

In step 303, the AMF may transmit an Nsmf_PDUSession_CreateSMContext Request message to the selected SMF.

The message transmitted by the AMF may include at least one of a SUPI, a selected DNN, a UE requested DNN, S-NSSAI(s), a PDU session ID, an AMF ID, a request type, [PCF ID, same PCF selection indication], priority access, a small data rate control status, an N1 SM container (PDU session establishment request), user location information, an access type, a RAT type, a PEI, a generic public subscription identifier (GPSI), UE presence in a local area DN (LADN) service area, subscription for PDU session status notification, a DNN selection mode, trace requirements, a control plane CIOT 5GS optimization indication, a control plane only indicator, a satellite backhaul category, a geostationary orbit (GEO) satellite ID, [PVS FQDN(s) and/or PVS IP address(es), onboarding indication], or a disaster roaming service indication.

If a request type is set to be “Initial Request with UI,” the message transmitted by the AMF may include a user ID. In addition, a PCF ID, a same PCF selection indication, etc., are configured so that the SMF may select a PCF configured to be able to provide a customized service for a corresponding user.

In step 304, if subscriber information corresponding to a requested SUPI, DNN, and S-NSSAI does not exist in the SMF, the SMF may transmit an Nudm_SDM_Get message to a UDM to request SM subscription data of the UE from the UDM. The message transmitted by the SMF may include at least one of a SUPI, SM subscription data, a selected DNN, an S-NSSAI of a HPLMN, a serving PLMN ID, or a network identifier (NID).

If a request type is set to be “Initial Request with UI,” the SMF may request, from the UDM, user profile (user profile_SM) information as well as SM subscription data information of the UE. The user profile information may be stored in at least one of the UDM, a UDR, or other network devices. Although a description is provided under an example where the user profile information is stored in the UDM, the disclosure is limited thereto.

In order to bring, from the UDM, user profile (user profile_SM) information related to a session (e.g., an SM), the SMF may add, in the request message, a user ID (user identifier) as well as a subscriber ID (e.g., SUPI) and transmit the message. In addition, a requested data type (subscription data type(s)) may be set to be user profile_SM. User profile_SM information received by the SMF from the UDM may include the above information.

The SMF may generate user-customized PDU session context data, based on SM subscription data information and user profile (user profile_SM) information.

In step 305, the SMF may transmit, to the AMF, an Nsmf_PDUSession_CreateSMContext Response message or an Nsmf_PDUSession_UpdateSMContext Response. The message transmitted by the SMF may include at least one of the following information: a cause, an SM context ID, or N1 SM container (PDU session rejection cause).

In step 306, a PDU session authentication/authorization procedure may be performed. More specifically, if secondary authentication/authorization is required, the SMF may perform a PDU session establishment authentication/authorization procedure with a DN-AAA server. In step 307a, the SMF may select a PCF. More specifically, if a dynamic policy and charging control (PCC) is applied to a PDU session, the SMF may select a PCF and establish an SM policy association.

The SMF may consider at least one of the following information to select a PCF for a generated PDU session: local service provider (operator) policies, a DNN, an S-NSSAI, a SUPI, a PCF selected for the UE, a PCF group ID provided by the AMF (a PCF set ID), or a same PCF selection indication.

The SMF may establish an SM policy association with the PCF and may request default PCC rules for a PDU session. If the message from AMF indicates that the PDU session is established for user identifier(s) (e.g., a request type is set to be “Initial Request with UI” or an indication informing session is for user identifier(s)), a selected PCF (PCF selected for user), a PCF group ID provided by the AMF (a PCF set ID), and a same PCF selection indication are configured, the SMF may select the corresponding PCF for a terminer user (e.g., SMF selects the PCF which supports user identifier(s)).

In step 307b, the SMF may perform an SM policy association configuration procedure with the PCF. Through the SM policy association configuration procedure, the SMF may receive default PCC rules applied to a generated PDU session from the PCF.

If a request type is set to be “Initial Request with UI,” the SMF may transmit a user ID together with a subscriber ID to the PCF while performing an SM policy association configuration procedure. In addition, the SMF may transmit, to the PCF, information, such as UI-charging characteristics information, UI-session-AMBR, or UI-subscribed QoS information, included in user profile_SM data received from the UDM.

The PCF may generate user-specific policy information, based on user-specific data received from the SMF and provide the generated information to the SMF. The user-specific policy information may include at least one of the following: UI-charging information, UI-authorized session-AMBR, and UI-authorized default 5QI/ARP. However, according to various embodiments, the user-specific data transmitted by the SMF to the PCF or the user-specific policy information transmitted by the PCF to the SMF may also include more information other than the above values.

In step 308, the SMF may select a UPF to serve a generated PDU session.

The SMF may consider at least one of the following information to select a UPF: a UPF's dynamic load, a UPF location available at the SMF, a DNN, a PDU session type, an SSC mode, a UE subscription profile, a DNAI, an S-NSSAI, an access technology, information related to UP topology, support for UPF allocation of an IP address/prefix, or support for high latency communication.

In step 309, the SMF may perform an SM policy association modification procedure. Through the SM policy association modification procedure, the PCF may update a policy for the SMF. In addition, a PCC rule based on a URSP rule for a PDU session may be generated.

In steps 310a and 310b, establishment and modification of an N4 session may be performed between the SMF and the selected UPF.

Referring to step 310a, for a procedure of establishment and modification of an N4 session, the SMF may transmit at least one of the following information to the UPF: packet detection and enforcement and reporting rules.

If a request type is set to “Initial Request with UI,” an N4 session context value may include values such as user-specific packet detection rules (PDRs), forwarding action rules (FARs), multi-access rules (MARs), usage reporting rules (URRs), QOS enforcement rules (QERs), and session reporting rules (SRRs).

In step 311, the SMF may transmit an Namf_Communication_NIN2MessageTransfer message to the AMF.

The message transmitted by the SMF may include at least one of a PDU session ID, N2 SM information (PDU session ID, QFI(s), QoS profile(s), CN tunnel info, S-NSSAI from an allowed NSSAI, session-AMBR, PDU session type, UP security enforcement information, UE integrity protection maximum data rate, RSN, PDU session pair ID, TL-container), or an N1 SM container (PDU session establishment accept/reject).

The N1 SM container (PDU session establishment accept) message included in the message transmitted by the SMF may include at least one of [QOS rule(s) and QoS flow level QoS parameters if needed for QoS flow(s) associated with the QoS rule(s)], a selected SSC mode, S-NSSAI(s), a UE requested DNN, an allocated IPv4 address, an interface identifier, session-AMBR, a selected PDU session type, [reflective QOS timer (if available)], [P-CSCF address(es)], [control plane only indicator], [header compression configuration], [always-on PDU session granted], [small data rate control parameters], [small data rate control status], [serving PLMN rate control], or [PVS FQDN(s) and/or PVS IP address(es)].

If a request type is set to be “Initial Request with UI,” N2 SM information may include at least one of the following user-specific QoS information: UI-QFI(s), UI-QoS profile(s), or UI-session-AMBR. In addition, an N1 SM information [PDU session establishment accept] message may include at least one of the following user-specific QoS information: UI-QOS rule(s), UI-QOS flow level QoS parameters, or UI-session-AMBR.

In step 312, the AMF may transmit, to a (R) AN, an NAS message (e.g., N2 PDU session request) including N2 SM information and a PDU session establishment accept message.

In step 313, the (R) AN may transmit, to the UE, an NAS message including a PDU session establishment accept message (e.g., AN-specific resource setup) received from the AMF.

In step 314, the (R) AN may transmit an N2 PDU session response message to the AMF.

The message transmitted by the (R) AN may include at least one of a PDU session ID, a cause, N2 SM information (PDU session ID, AN tunnel info, list of accepted/rejected QFI(s), UP enforcement policy notification, TL-container, established QoS flows status (active/not active) for QoS monitoring configuration for congestion information, established QoS flows status (active/not active) for ECN marking for L4S, or PDU set-based handling support indication.

In step 315, the AMF may transmit an Nsmf_PDUSession_UpdateSMContext Request message to the SMF. The message transmitted by the AMF may include at least one of an SM context ID, N2 SM information, or a request type.

In steps 316a and 316b, the SMF and the UPF may exchange an N4 session modification request/response message. If a particular UPF function is not supported due to a UP resource problem, the UPF function may be deactivated. If configuration of a PDU session is rejected, an N4 session for the PDU session may be released.

In step 316c, the SMF may perform a procedure of registering information related to a corresponding PDU session in the UDM by using an Nudm_UECM_Registration message. The message transmitted by the SMF may include at least one of a SUPI, a DNN, an S-NSSAI of a HPLMN, a PDU session ID, an SMF identity), a serving node PLMN ID, or [NID].

In step 317, the SMF may transmit an Nsmf_PDUSession_UpdateSMContext

Response message to the AMF.

In step 318, if a PDU session establishment procedure is not successful, the SMF may notify the AMF of same by transmitting an Nsmf_PDUSession_SMContextStatusNotify message thereto.

In step 319, if a PDU session type requested to be generated is IPV6 or IPV4v6, the SMF may generate an IPV6 router advertisement message and transmit same to the UE.

In step 320, if 5GS bridge/router information is available, the SMF may start an SM policy association modification procedure with the PCF.

In step 321, if a PDU session establishment procedure fails, the SMF may release a notification service for change of SM subscription data.

Each of various procedures or operations illustrated in FIG. 3 described above is not necessarily an essential element. Rather, the disclosure is not limited thereto and may include only at least one of some of the operations or a combination of some operations. Additionally, the pieces of information included in each message within the aforementioned procedures is not necessarily an essential element, and only some of the pieces of information may be included. Furthermore, the names of the pieces of information are also merely examples, and any terms may be used as long as it has the same or similar meaning.

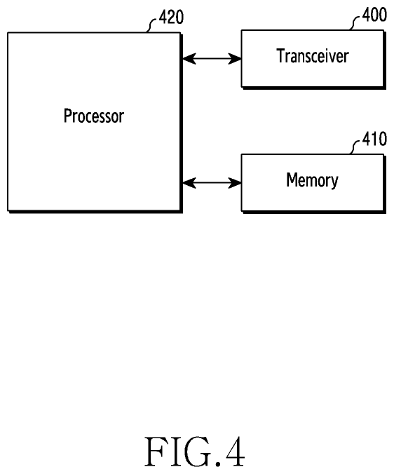

FIG. 4 illustrates a UE according to an embodiment.

Referring to FIG., the UE includes a processor 420 which controls the overall operation of the UE, a transceiver 400 that includes a transmitter and a receiver, and a memory 410. The example given above is not limiting, and the UE may include more components than those illustrated in FIG. 4 or may include less components than those illustrated in FIG. 4.

The transceiver 400 may transmit/receive signals with NE or other UEs. The signals transmitted/received with NE may include control information and data. In addition, the transceiver 400 may receive signals through a radio channel, output the same to the processor 420, and transmit signals output from the processor 420 through the radio channel. The processor 420 may control the UE to perform operations according to any one of the above-described embodiments. The processor 420, the memory 410, and the transceiver 400 are not necessarily implemented as separate modules, but may be implemented as a single component unit such as a single chip. Also, the processor 420 and the transceiver 400 may be electrically connected to each other. In addition, the processor 420 may include an application processor (AP), a communication processor (CP), a circuit, an application-specific circuit, a controller, or at least one processor.

The memory 410 may store data such as basic programs for operations of the UE, application programs, and configuration information. In particular, the memory 410 provides the stored data at the request of the processor 420. The memory 410 may include a storage medium such as a read only memory (ROM), a random access memory (RAM), a hard disk, a compact disc (CD)-ROM, a digital versatile disc (DVD), or a combination of storage media. In addition, the memory 410 may include multiple memories. Furthermore, the processor 420 may perform the above-described embodiments of the disclosure, based on the programs for performing the embodiments, stored in the memory 410.

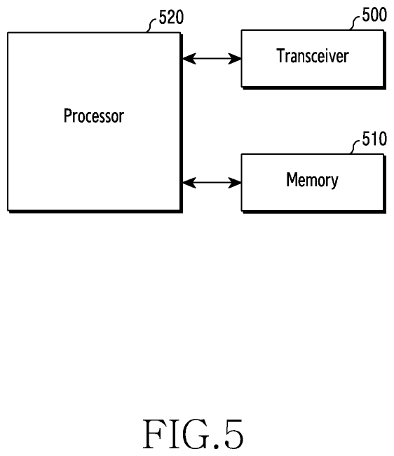

FIG. 5 illustrates a BS or network entity according to an embodiment.

Referring to FIG. 5, the network entity includes a processor 520 that controls the overall operation of the network entity, a transceiver 500 which includes a transmitter and a receiver, and a memory 510. The example given above is not limiting, and the network entity may include more components than those illustrated in FIG. 5 or may include less components than those illustrated in FIG. 5.

The transceiver 500 may transmit/receive signals with at least one of other NE or UEs. The signals transmitted/received with at least one of other NE or UEs may include control information and data.

The processor 520 may control the network entity to perform operations according to any one of the above-described embodiments. The processor 520, the memory 510, and the transceiver 500 are not necessarily implemented as separate modules, but may be implemented as a single component unit such as a single chip. Furthermore, the processor 520 and the transceiver 500 may be electrically connected to each other. In addition, the processor 520 may include an AP, a CP, a circuit, an application-specific circuit, a controller, or at least one processor.

The memory 510 may store data such as basic programs for operations of the network entity, application programs, and configuration information. In particular, the memory 510 provides the stored data at the request of the processor 520. The memory 510 may include a storage medium such as a ROM, a RAM, a hard disk, a CD-ROM, a DVD, or a combination of storage media. In addition, the memory 510 may include multiple memories. Furthermore, the processor 520 may perform the above-described embodiments of the disclosure, based on the programs for performing the embodiments, stored in the memory 510.

The above-described configuration diagrams, illustrative diagrams of control/data signal transmission methods, illustrative diagrams of operation procedures, and structural diagrams are not intended to limit the scope of the disclosure. That is, all constituent elements, entities, or operation steps described in the embodiments of the disclosure should not be construed as being essential for the implementation of the disclosure, and the disclosure may be implemented without impairing the essential features of the disclosure by including only some constituent elements. Also, the above respective embodiments may be employed in combination, as necessary. For example, the methods proposed in the disclosure may be partially combined with each other to operate a network entity and a terminal.

The above-described operations of a BS or terminal may be implemented by providing any unit of the BS or terminal device with a memory device storing corresponding program codes. That is, a controller of the BS or terminal device may perform the above-described operations by reading and executing the program codes stored in the memory device by means of a processor or CPU.

Various units or modules of an entity, a BS device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein. These programs (software modules or software) may be stored in non-volatile memories including a random access memory and a flash memory, a ROM, an electrically erasable programmable ROM (EEPROM), a magnetic disc storage device, a CD-ROM, DVDs, other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. As an example, a part of a first embodiment of the disclosure may be combined with a part of a second embodiment to operate a BS and a terminal. Moreover, although the above embodiments have been described based on the 5G or NR system, other variants based on the technical idea of the embodiments may also be implemented in other communication systems such as LTE, LTE-A, or LTE-A-Pro systems.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. An access and mobility management function (AMF) entity in a mobile communication system, the AMF entity comprising:
a transceiver; and
a controller coupled with the transceiver and configured to:
receive, from a user equipment (UE), a protocol data unit (PDU) session establishment request message including a user identifier and a request type of a PDU session establishment request,
identify that the request type indicates that the PDU session establishment request is for the user identifier, and
select a session management function (SMF) entity associated with a PDU session establishment based on the user identifier.

2. The AMF entity of claim 1, wherein the controller is further configured to transmit, to the SMF entity, the PDU session establishment request message including the user identifier and the request type.

3. The AMF entity of claim 1, wherein the PDU session establishment request message further includes user profile information corresponding to the user identifier, and
wherein the SMF entity is selected based on the user identifier and the user profile information corresponding to the user identifier.

4. The AMF entity of claim 1, wherein the PDU session establishment request message further includes at least one of a requested data network name (DNN) for each user or single-network slice selection assistance information (S-NSSAI) for each user.

5. A session management function (SMF) entity in a mobile communication system, the SMF entity comprising:
a transceiver; and
a controller coupled with the transceiver, and configured to:
receive, from an access and mobility management function (AMF) entity, a protocol data unit (PDU) session establishment request message including a user identifier and a request type of a PDU session establishment request,
identify that the request type indicates that the PDU session establishment request is for the user identifier, and
receive, from a unified data management (UDM) entity, user profile information corresponding to the user identifier.

6. The SMF entity of claim 5, wherein the controller is further configured to select, a policy control function (PCF) entity associated with a PDU session establishment based on the user identifier.

7. The SMF entity of claim 6, wherein the controller is further configured to:
transmit, to the PCF entity, the user identifier, and
receive, from the PCF entity, policy information corresponding to the user identifier.

8. The SMF entity of claim 5, wherein the PDU session establishment request message further includes at least one of a requested data network name (DNN) for each user or single-network slice selection assistance information (S-NSSAI) for each user.

9. A method performed by an access and mobility management function (AMF) entity in a mobile communication system, the method comprising:
receiving, from a user equipment (UE), a protocol data unit (PDU) session establishment request message including a user identifier and a request type of a PDU session establishment request;
identifying that the request type indicates that the PDU session establishment request is for the user identifier; and
selecting a session management function (SMF) entity associated with a PDU session establishment based on the user identifier.

10. The method of claim 9, further comprising transmitting, to the SMF entity, the PDU session establishment request message including the user identifier and the request type.

11. The method of claim 9, wherein the PDU session establishment request message further includes user profile information corresponding to the user identifier, and
wherein the SMF entity is selected based on the user identifier and the user profile information corresponding to the user identifier.

12. The method of claim 9, wherein the PDU session establishment request message further includes at least one of a requested data network name (DNN) for each user or single-network slice selection assistance information (S-NSSAI) for each user.

13. A method performed by a session management function (SMF) entity in a mobile communication system, the method comprising:
receiving, from an access and mobility management function (AMF) entity, a protocol data unit (PDU) session establishment request message including a user identifier and a request type of a PDU session establishment request;
identifying that the request type indicates that the PDU session establishment request is for the user identifier; and
receiving, from a unified data management (UDM) entity, user profile information corresponding to the user identifier.

14. The method of claim 13, further comprising selecting, a policy control function (PCF) entity associated with a PDU session establishment based on the user identifier.

15. The method of claim 14, further comprising:
transmitting, to the PCF entity, the user identifier, and
receiving, from the PCF entity, policy information corresponding to the user identifier.

16. The method entity of claim 13, wherein the PDU session establishment request message further includes at least one of a requested data network name (DNN) for each user or single-network slice selection assistance information (S-NSSAI) for each user.
